(19) United States
(12) Patent Application Publication
(10) Pub. No.: US 2011/0176974 A1
(43) Pub. Date: Jul. 21, 2011

(54) CRYSTALLIZER

(76) Inventor: Nikolay Nikolaevich Skaldin, Moscow (RU)

(21) Appl. No.: 13/121,616

(22) PCT Filed: Apr. 14, 2009
(86) PCT No.: PCT/RU09/00179

§ 371 Date: Mar. 29, 2011

(30) Foreign Application Priority Data
Sep. 30, 2008 (RU) 2008138655

(51) Int. Cl. B01D 9/00

(52) U.S. Cl. 422/245.1

(57) ABSTRACT

A crystallizer including a cylindrical body with a bottom, a lid and a vertical shaft which is mounted on bearings and is provided with a rotary drive. The inner surfaces of the body and lid are covered with a two-layer coating. The first layer, in the form of a liner, is attached to the walls of the body by means of a high-temperature adhesive. The second layer is made of fine-grained graphite and is glued to the first layer. The bearings are arranged in a unit which is designed to allow the supply of a cooling liquid. The described subject matter makes it possible to improve the quality of ingots since the thermal deformation of the crystallizer and the interaction of the ingot with the body walls are excluded owing to the increased velocity range of the bearings.

### FIELD OF THE INVENTION

The invention is related to metallurgical production and is intended for making pre-rolled ingots with preset characteristics from aluminum alloys.

### BACKGROUND OF THE INVENTION

RU Patents 79563, 1082310, 1088653, 2039830, 2055682, 53193, 2299924, 2312156 methods and devices for crystallization of aluminum alloys are known. But, none of the listed technical decisions allows to rotate the retainer with speeds providing overloading of 20 G and the more so 250 G.

The created and widely applied in modern industry aluminum alloys are divided into two categories: deformed (rolled) and cast. To deformed alloys in particular, aluminum and magnesium alloys are related. Increase of magnesium content in an alloy would result in abrupt improvement of its mechanical properties. For example, it increases tensile strength, inoxidizability et cetera. Available today in the world crystallization technologies do not allow to create deformed (rolled) alloys with magnesium content more than 6%. After rolling they become unstable and lose their functional properties.

A crystallizer containing a vertical cylindrical body with a bottom is known, housing a mixing device consisting of a vertical shaft with blades fixed along its length and a shaft drive; at that, the body is provided with a face-type shell installed with a gap round the shaft with blades. The tapered lower part of the shell is located above the bottom, and every blade of the mixing device consists of two bent plates making a part of paraboloid fixed vertically and oppositely to one another so that their lower edges are located on one line and the area of one plate exceeds the area of other one and each blade located above is turned in the horizontal plane in relation to the blade located beneath by 40-50° C. The shaft of the mixing device is set with a possibility of rotation, at that, the lower blades have areas located beyond the conical part of the shell and are made so that the shape of their lower edges is similar to the form of the body bottom (RU 22039830).

The drawbacks of the known technical decision is low quality of ingots associated with the inevitable polycrystalline structure that practically doesn't have a dominant crystallographic orientation and complexity of design due to the need to have a mixing device.

A technical decision foreseeing receiving of ingots from aluminum alloys with the preset crystalline structure and preset characteristics in the gravity field with the use of crystallizer based on centrifuge is known, i.e. providing a possibility of rotation of the cylindrical body with the bottom, lid and vertical shaft mounted on bearings and provided with the rotation drive (RU 2312156).

The drawbacks of the known technical decision is absence of constructive decision, ensuring in practice obtaining of an alloy with the preset crystalline structure in the gravity field, heterogeneity of surface layer of ingots related to possibility of interaction of the crystallized melt with the body walls under the conditions of the gravity field; as a result the quality of ingots deteriorates causing rapid wear of the body due to the effect of the melt in the gravity field as well as narrowness of functional possibilities conditioned by limitations of rotation speed. Thus, within the framework of existing today technologies in the world, it is impossible to create deformed (rolled) alloys with magnesium content more than 6%. After rolling they become unstable and lose their functional properties.

### SUMMARY OF THE INVENTION

The technical task of the invention is creation of an effective crystallizer and expansion of arsenal of crystallizers for aluminum alloys. The technical result ensuring solution of the set task consists in that it allows to practically make ingots from aluminum alloys in the gravity field, improve quality of ingots due to exclusion of temperature deformation of the retainer in which crystallization takes place, exclusion of interaction between the ingot and body walls, preservation of the body is gained due to its protection from the high temperature melt. Functional possibilities of obtaining alloys of different structures are also extended due to expansion of the range of speeds of bearings and due to minimization of variation of temperature deformation of the retainer, in which crystallization takes place, optimization of interaction conditions of ingots with the body walls. Maximum preservation of the body is attained due to its protection from the influence of high temperature melt; functional possibilities of obtaining alloys of different structures are also extended due to expansion of the range of bearings speed. The applied for crystallizer, when rotating with the speed providing overloading of the melt in the range from 20 G to 250 G, optimizes conditions of crystallization of additives due to boost of diffusive processes in melts at the stage of crystalline structure forming As a result alloys with considerably improved (by 25-30%) functional properties are obtained. The term “functional properties” implies a number of concrete properties. Depending on the purpose of the alloy, it can be made with high tensile strength, another alloy can be made with the high index of ductility, and in some other alloy it is possible to get a single-crystal structure.

The nature of the invention consists in that the crystallizer contains a cylindrical rotating body with a bottom, a lid and a vertical shaft, which is mounted on bearings and is provided with a rotary drive. The inner surfaces of the body and the lid are covered with a two-layer coating. The first layer is made in the form of a lining that is attached to the walls of the body by means of a heat-resistant adhesive. The second layer is made of fine-grained graphite that is pasted to the lining with the help of a heat-resistant adhesive. The bearings are housed in a unit which is designed to allow the supply of a cooling liquid. Preferable in particular cases:

bearings are made in the form of conical angular ball bearings and the shaft rotation drive is made in the form of a slave pulley of a flexible, for example V-belt drive;

the lid is provided with a collar for placing in a ring slot, which is made additionally on the body flange;

the bottom of the body is made with an opening in which a hub with a conical opening for installation of the shaft is fixed;

the block of bearings is provided with combined stuffing-boxes being a graphite cord and rubberized metal cuffs; -the body is made of heat-resistant steel;

the lining layer is in the form of graphite made of fine-grained graphite with the thickness making half of that of the lining;

the lining layer is made, for example of chamotte 30 mm thick, and the graphite layer—15 mm thick; -the crystallizer is provided with means of body temperature and crystallized melt temperature control;

the lining is made of light-weight heat-resistant material with a specific density from 1.0 to 1.8 g/cm³ with the coefficient of heat conductivity from 0.14 to 0.72 watt/meter*kelvin, and the second layer is made with an internal diameter from 300 to 3000 mm and with the height from the bottom lining to lid lining from 50 mm to 1000 mm; the lining layer is made, for example of ceramics on the basis of wollastonite.

### PREFERABLE VARIANT OF IMPLEMENTATION OF INVENTION

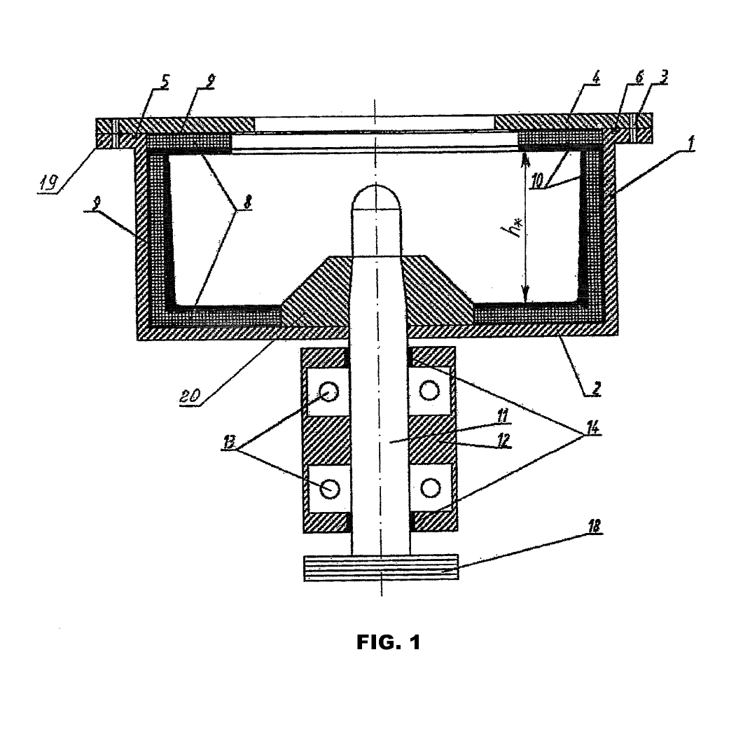

FIG. 1 shows the crystallizer design scheme. The crystallizer consists of a container for crystallization of melt made in the form of a cylindrical body (1) with certain dimensions, for example: diameter 1000 mm, height 400 mm, wall thickness 25 mm. In the lower part of the body (1) a 25 mm thick bottom (2) from heat-resistant steel 12X18H1OT is welded. The height of the body (1) is equal, for example to 400 mm. The upper part of the body (1) is provided with a flange (19), which has eight screw-thread openings (3) with the thread M14 for fastening of lid (4) having thickness, say 15 mm. Flange (19) has a circular slot (groove) (5), and lid (4) has a circular collar (6), which when tightening bolts (7) goes into slot (5) thus, giving necessary rigidity to the upper part of the crystallizer body (1).

Internal surface of the body (1) and bottom (2) have a double layer lining of internal surface, i.e. they ate lined by layer (8) made of a light-weight heat-resistant material, for example shamotte or ceramics based on wollastonite, with specific density from 1.0 to 1.8 g/cm³ and coefficient of heat conductivity from 0.14 to 0.72 watt/meter*kelvin. Layer (8) is pasted by a layer of heat-resistant glue (9). After drying of the glue the surfaces of layer (9) are preliminary turned to remove radial and butt-end beating with the purpose to eliminate the disbalance of the whole construction. On the turned surface the second layer (10) of lining made of a fine-grained graphite grade MGP-7, for example 15 mm thick, is applied with the help of a heat-resistant glue. Layer (10) is made of internal lining with diameter from 300 to 3000 mm and the height from the bottom lining to the lid lining from 50 mm to 1000 mm. After drying of the glue the surface of layer (10) is finally turned to obtain a 3 degrees slope on the lateral surface and 1 degree on the bottom (2).

Into the bottom (2) of the body (1) the hub (20) with a conical hole (not indicated) is welded; the shaft (11) being the axis of rotation of the crystallizer is inserted into this hole. The body (1) is fixed on the shaft (11) by a nut (not shown) providing a possibility of joint rotation with the shaft (11). Shaft (11) is mounted on bearings and for this purpose it is vertically inserted into a block of bearings (12), which has two conical angular ball bearings (13) (their number can be 3, 5, 10 et cetera, but no less than two). In the upper and lower parts of the block of bearings (12) combined stuffing-boxes (14) are fixed, being a graphite cord (15) and rubberized (rubber and metal) cuffs (16), intended for pressurizing of the block of bearings (12) through which a cooling liquid circulates, for example high-temperature oil. The oil in turn goes to the tank (not shown), which is made of aluminum. When oil is pumped through, the tank takes away the heat of the heated oil and cools it. Circulation of oil is provided with the help of a pump (not shown) installed in this tank.

In the lower part of the shaft (11) there is a slave pulley (18) to which rotation is passed through a flexible V-belt drive (not shown), for example from a DC motor with the rating of 12 kw (not shown). Monitoring and control of the crystallizer is carried out from a control desk (not shown), allowing to change and control rotation speed of the crystallizer, temperature of the body (1) before the melt is poured in and the temperature of the melt from the moment it is poured to the moment of extraction of the finished ingot.

The crystallizer made in accordance with this technical decision can have the followings characteristics: crystallizer with a minimum effective diameter 300 mm can be revolved with a speed in the range from 345 rpm to 1221 rpm or with the angular velocity of 36.16 radian/sec to 1221 radian/sec. The indicated values correspond to a minimum (20 G) and maximum (250 G) overload;

a crystallizer with a maximum effective diameter 3000 mm revolves with a speed in the range from 109.2 rpm to 386.2 rpm or 11.44 radian/sec to 40.44 radian/sec, which corresponds to the minimum (20 G) and maximum (250 G) overload accordingly. In addition to the said, it is necessary to set the optimum effective height h* of the crystallizer, i.e. the height from the bottom lining to the lid lining, which must be in the range from 50 mm to 1000 mm, i.e. the crystallizer with diameter 30 0mm can have effective height from 50 mm to 1000 mm. This is also true for the crystallizer with the diameter of 3000 mm. The crystallizer functions as follows.

Into a preheated crystallizer, that revolves with a certain speed required for orientation of the melt along the outside diameter of the bottom (2), through the opening in the lid (4) aluminum melt with the temperature of 750-900° C. is poured. The lining consisting of layers 8, 10 prevents the body (1) from drastic heating and temperature deformation. Right after completion of the pouring process, rotation speed of the shaft (11) with the body (1) of the crystallizer is increased to the value corresponding to the value of overload in the melt in the range from 20 G to 250 G under the effect of centrifugal force.

When pumping oil through the block (12) heat is taken away thus, cooling the body (1) with the melt. Supply of a cooling liquid in the block (12) allows the bearings (13) to operate in such a wide range of angular velocities. Thus, crystallization of the melt is accompanied by a powerful gravity field. The effect of the gravity field on the crystallizable melt is similar to creation of respective fields of super cooling in it. The effect of the gravity field intensifies diffusive processes in the aluminum alloy melt that results in obtaining solids of infusion-substitution type with a minimum emission of eutecticum. At a rotation speed providing overloading of the melt in the range from 20 G to 250 G, the conditions of crystallization of additives change due to boosting of diffusive processes in melts on the stage of crystalline structure formation. The technical result arrived at here consists in obtaining of alloys with considerably (up to 25-30%) improved functional properties.

As a result the ingot even at a somewhat polycrystalline structure has a dominant crystallographic orientation in the preset direction, constituting no less than 80-85% out of all possible orientations. The lifetime of the melt is 12-15 sec/kg. Layers 8-10 are made of inactive amorphous materials and prevent the body (1) from sticking to aluminum under the influence of gravity field; they protect the melt and then the ingot from ingress of admixtures from the crystal lattice of the body (1) material.

After crystallization of the melt (transition to solid state) rotation speed of the crystallizer shaft (11) are kept on for some time until the required ingot temperature is attained and then the temperature is decreased until a complete stop of the crystallizer body (1). In the body (1) the ingot of a circular shape is received, which is removed after opening of the lid (4) with the help of a functional device when the crystallizer body (1) temperature reaches a certain temperature. The “K” ratio of the outside diameter of the ingot to its height is in the range from 2.5 to 10, and wall thickness of the ingot is determined, preferably as a product of Kx20.

As a result the best combination of durability and ductility of the received alloy is attained: tensile strength 320-330 MPa at the percent elongation 30-40%. The received material can be used as an engineering material for automobile industry.

Thus, an effective crystallizer allowing in practice to receive an alloy with the preset crystalline structure in the gravity field has been created, and the arsenal of crystallizers for aluminum alloys has been extended.

Thus, the quality of ingots has been improved due to exclusion of temperature deformation of the retainer in which crystallization takes place and due to exclusion of interaction of ingots with the body walls. Functional possibilities are enlarged due to extension of the range of bearings speed.

Application of this crystallizer for receiving aluminum alloys allows to actually obtain deformed (rolled) alloys with magnesium content of 10-15-20%, which in turn leads to considerable improvement of their mechanical properties. As a result, it is possible to get an aluminum sheet, which will be durable as steel and as light as aluminum, from which it will be possible to make different parts using the plastic deformation method (parts of car body, airplanes etc.). I.e. due to its unique durability car bodies, airplanes etc. can become even lighter.

Thus, an effective crystallizer allowing in practice to receive an alloy with the preset crystalline structure in the gravity field has been created, and the arsenal of crystallizers for aluminum alloys has been extended.

Thus, quality of ingots has been improved due to exclusion of temperature deformation of the retainer in which crystallization takes place and due to exclusion of interaction of ingots with the body walls. Functional possibilities are enlarged due to extension of the range of bearings speed in combination with the rotary drive as well as due to the possibility of body rotation around its axis in vertical position with limitation of rotation speed depending on the interval of required overload in the range of 20 G to 250 G.

Industrial applicability

This invention can be implemented with the help of multipurpose easily available modern equipment, which is widely spread in the industry.

1. A crystallizer containing an installed cylindrical body, capable to rotate, with the bottom, lid and vertical shaft mounted on bearings and provided with a drive, differs in that the body and the lid have a two-layer lining of internal surfaces, besides, one layer of lining is made as a fettling fixed by a heat-resistant glue to the body walls, and the second layer of lining is made of a fine-grained graphite fixed by a heat-resistant glue to the fettling; the bearings are mounted in a block designed with a possibility to circulate a cooling liquid.

2. The crystallizer of claim 1, characterized in that the bearings are made as conical angular ball bearings, and the shaft drive is made as a slave pulley of a flexible, for example V-belt drive.

3. The crystallizer of claim 1, characterized in that the lid is provided with a collar for placing in a ring slot additionally made on the body flange.

4. The crystallizer of claim 1, characterized in that the bottom of the body is made with an opening in which the hub is fixed with a conical opening for installation of the shaft.

5. The crystallizer of claim 1, characterized in that the block of bearings is provided with the combined stuffing-boxes being a graphite cord and rubberized metal cuffs.

6. The crystallizer of claim 1, characterized in that the body is made of heat-resistant steel.

7. The crystallizer of claim 1, characterized in that the layer of the lining being a graphite, is made of a fine-grained graphite with a thickness making half of thickness of the lining made in the form of fettling.

8. The crystallizer of claim 7, characterized in that the layer of fettling is made of shamotte 30 mm thick, and the layer of graphite is 15 mm thick.

9. The crystallizer of claim 1, characterized in that it is provided with means of body and the crystallized melt temperature control.

10. The crystallizer of claim 1, characterized in that the fettling is made of a light-weight heat-resistant material with a specific density from 1.0 to 1.8 g/cm³ and coefficient of heat conductivity from 0.14 to 0.72 watt/meter*kelvin, and the second layer is made with the internal diameter from 300 to 3000 mm and with the height from the bottom lining to the lid lining from 50 mm to 1000 mm.

11. The crystallizer of claim 10, characterized in that the layer of lining is made of ceramics on the basis of wollastonite.
